(19) United States
(12) Patent Application Publication
(10) Pub. No.: US 2024/0127380 A1
(43) Pub. Date: Apr. 18, 2024

(54) SYSTEMS AND METHODS FOR OBTAINING EVIDENCE OF ONLINE COMMERCIAL USE OF A TRADEMARK

(71) Applicant: Camelot UK Bidco Limited, London (GB)

(72) Inventors: Ann Smet, Stekene (BE); Jan Waerniers, Aalter (BE); Akanksha Mishra, Miami, FL (US); Peter Keyngnaert, Deinze (BE); Pieter-Jan Ghesquiere, Rotselaar (BE)

(21) Appl. No.: 18/046,392

(22) Filed: Oct. 13, 2022

(51) Int. Cl. G06Q 50/18; G06F 16/9532; G06F 16/9538; G06F 16/955

(52) U.S. Cl. CPC G06Q 50/184; G06F 16/9532; G06F 16/9538; G06F 16/9566

(57) ABSTRACT

Systems and methods are described for obtaining evidence of online commercial use of a trademark. In embodiments, a query generator receives information about the trademark and generates search queries based thereon. A search results collector submits the search queries to at least one Internet search engine to obtain a set of search results pertaining to a plurality of web pages. A web page content analyzer obtains and analyzes page content of each web page in the plurality of web pages to generate a brand score indicative of a degree of confidence that the web page includes the trademark and a commercial score indicative of a degree of confidence that the web page relates to commerce. A user interface (UI) manager presents information about each web page in the plurality of web pages via a UI, including associated brand score and commercial score representations, in a ranked order based on relevance.

### BACKGROUND

An overwhelming amount of data has been made available for retrieval over the Internet or over other communication networks. Such data is available from a large number of data sources curated by data service providers. Some users seeking to find data using key terms entered into a search engine or other processes often cannot efficiently find the data they are looking for. Moreover, once a set of search results is provided, some users may not be able to use the results in a meaningful way. Additionally, some users may not possess the skill or time necessary for developing precise search terms to ensure that results of a search are comprehensive and complete, and also may not possess the skill or time necessary for interpreting large volumes of data returned in response to searches.

The above challenges may be particularly acute when one is trying to obtain evidence of online commercial use of a trademark. A party may be interested in having a registered trademark revoked on the grounds of non-use, e.g., to clear the way for registration of their own trademark. Revocation on the grounds of non-use is a legal procedure, available in many countries, for removing a registered trademark because the trademark has not been used in commerce for a continuous period (e.g., three years or five years) since the trademark was registered. To determine whether revocation on the grounds of such non-use is possible for a given registered trademark, one needs to obtain evidence regarding whether or not the trademark has been used to sell goods or services over a given period. Further, a party may also be interested in obtaining evidence of online commercial use of a trademark to assess the commercial context of the trademark.

One approach to obtaining evidence of the online commercial use of a trademark is to perform keyword searching using an Internet search engine. However, such an approach presents several challenges. First, as noted above, the user may not possess the skill or time necessary to craft queries that are likely to produce relevant results. Second, a search for web pages that include the word(s) of the trademark may return voluminous results, many of which may be irrelevant. This is particularly true if the trademark is not a coined term. To determine if the word(s) of the trademark are actually being used as a brand and/or in conjunction with the sale of goods or services, the user must invest considerable time either analyzing snippets of the web pages provided as part of the search results or browsing the actual web pages to inspect the word(s) in context. Scrolling through the search results and navigating to the relevant web pages can consume a significant amount of time and computing resources. Third, the order of presentation of web pages in the search results may be driven by factors such as whether and how often the search term(s) appear on the web page, with web pages including the greatest number of matches being ranked at the top. However, this may not be helpful to the user who is only interested in web pages where the trademark term(s) are being used as a brand and for commercial purposes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are described herein for obtaining evidence of online commercial use of a trademark. In embodiments, a query generator receives information about the trademark and generates search queries based thereon. A search results collector submits the search queries to at least one Internet search engine to obtain a set of search results pertaining to a plurality of web pages. A web page content analyzer obtains and analyzes page content of each web page in the plurality of web pages to generate a brand score indicative of a degree of confidence that the web page includes the trademark and a commercial score indicative of a degree of confidence that the web page relates to commerce. A user interface (UI) manager presents information about each web page in the plurality of web pages via a UI, including representations of the brand score and commercial score associated with each web page, in a ranked order based on relevance.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for obtaining evidence of online commercial use of a trademark in accordance with an embodiment.

FIG. 2 depicts a flowchart of a method for obtaining evidence of online commercial use of a trademark in accordance with an embodiment.

FIG. 3 depicts a flowchart of a method for generating search queries for obtaining evidence of online commercial use of a trademark in accordance with an embodiment.

FIG. 4 depicts a flowchart of a method for obtaining a set of search results for obtaining evidence of online commercial use of a trademark in accordance with an embodiment.

FIG. 5 depicts a flowchart of a method for generating a brand score for a web page in accordance with an embodiment.

FIG. 6 depicts a flowchart of a method for generating a commercial score for a web page in accordance with an embodiment.

FIG. 7 shows an example UI element via which information about a web page may be presented to a user in a system for obtaining evidence of online commercial use of a trademark in accordance with an embodiment.

FIG. 8 shows an example UI via which information about multiple web pages may be presented to a user in a system for obtaining evidence of online commercial use of a trademark in accordance with an embodiment.

FIG. 9 depicts a flowchart of a method for presenting an ordered view of information about multiple web pages identified by a system for obtaining evidence of online commercial use of a trademark in accordance with an embodiment.

FIG. 10 depicts a flowchart of a method for presenting an excerpt of text from a web page with text that contributed to one or more of a brand score or a commercial score for the web page highlighted therein in accordance with an example embodiment.

FIG. 11 depicts a flowchart of a method for presenting a rendering of a web page with elements that contributed to one or more of a brand score or a commercial score for the web page highlighted therein in accordance with an example embodiment.

FIG. 12 shows a block diagram of an example computing environment system in which proposed embodiments of the current disclosure may be implemented.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” “another embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

As used herein, the term “trademark” is intended to encompass any symbol, logo, image, word, and/or words legally registered, established by use, or asserted as representing a company, product or service. The word “trademark” also encompasses service marks.

As used herein, the term “goods/services” is to be interpreted as equivalent to the term “goods and/or services.”

The example embodiments described herein are provided for illustrative purposes and are not limiting. The examples described herein may be adapted to any type of method or system for obtaining evidence of online commercial use of trademark. Further structural and operational embodiments, including modifications/alterations, will become apparent to persons skilled in the relevant art(s) from the teachings herein.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section may be combined with any other embodiments described in the same section and/or a different section.

### II. Example Embodiments

As discussed in the Background Section above, for several reasons, a party (e.g., user) may wish to obtain evidence of online commercial use of a trademark. For example, a party may be interested in having a registered trademark revoked on the grounds of non-use, e.g., to clear the way for registration of their own trademark. Revocation on the grounds of non-use is a legal procedure, available in many countries, for removing a registered trademark because the trademark has not been used in commerce for a continuous period (e.g., three years or five years) since the trademark was registered. To determine whether revocation on the grounds of non-use is possible for a given registered trademark, one needs to obtain evidence regarding whether or not the trademark has been used to sell goods or services over a given period. The party may also be interested in obtaining evidence of online commercial use of a trademark to assess the commercial context of the trademark.

One approach to obtaining evidence of the online commercial use of a trademark is to perform keyword searching using an Internet search engine. However, such an approach presents several challenges. First, a user may not possess the skill or time necessary to craft queries that are likely to produce relevant results. Second, a search for web pages that include the word(s) of the trademark may return voluminous results, many of which may be irrelevant. This is particularly true if the trademark is not a coined term. To determine if the word(s) of the trademark are actually being used as a brand and/or in conjunction with the sale of goods or services, the user must invest considerable time either analyzing snippets of the web pages provided as part of the search results or browsing the actual web pages to inspect the word(s) in context. Scrolling through the search results and navigating to the relevant web pages can consume a significant amount of time and computing resources. Third, the order of presentation of web pages in the search results may be driven by factors such as whether and how often the search term(s) appear on the web page, with web pages including the greatest number of matches being ranked at the top. However, this may not be helpful to the user who is only interested in web pages where the trademark term(s) are being used as a brand and for commercial purposes.

Systems and methods are described herein for obtaining evidence of online commercial use of a trademark in a manner that addresses one or more of the foregoing challenges. In an embodiment, a query generator receives information about the trademark and generates search queries based thereon, wherein the information about the trademark includes at least a trademark name, an owner name and goods/services information. A search results collector submits the search queries to at least one Internet search engine to obtain a set of search results pertaining to a plurality of web pages, the search results pertaining to the plurality of web pages comprising at least a Uniform Resource Locator (URL) associated with each web page in the plurality of web pages. A web page content analyzer obtains page content of each web page in the plurality of web pages via the corresponding URL. The web page content analyzer analyzes the page content of each web page in the plurality of web pages to generate a brand score indicative of a degree of confidence that the web page includes the trademark. The web page content analyzer also analyzes the page content of each web page in the plurality of web pages to generate a commercial score indicative of a degree of confidence that the web page relates to commerce. A UI manager presents information about each web page in the plurality of web pages via a UI, including representations of the brand score and commercial score associated with each web page.

By generating the queries automatically based on the trademark information, embodiments described herein spare the user the time and labor associated with manually crafting the queries. Furthermore, as will be described herein, the process of automatically generating the queries may leverage query templates that have been specifically designed to capture web pages that use the word(s) of the trademark as a brand and/or in a commercial context. This increases the likelihood that relevant web pages are included within the scope of the search. This can also reduce the amount of computing resources that would otherwise be expended if a poorly crafted search query was used, which could result in the identification and analysis of numerous irrelevant web pages.

In an embodiment, a machine learning model may be used to automatically generate the search queries. For example, a machine learning model may be used that accepts as input the goods/services information associated with the trademark and extracts therefrom a set of keywords that may then be included in the search queries. As another example, a machine learning model may be used that accepts as input the goods/services information associated with the trademark and identifies a set of equivalent terms that may then be included in the search queries. Such embodiments may enhance the performance of the system in terms of identifying web pages that use the word(s) of the trademark as a brand and/or in a commercial context.

In another embodiment, the search queries are submitted to the at least one Internet search engine to obtain an initial set of search results and then the initial set of search results is filtered to eliminate web pages that correspond to irrelevant web pages identified in a blacklist. This approach can advantageously remove from further analysis web pages that are likely to be identified based on the search queries but that are also known to be irrelevant in terms of showing commercial use of the trademark, thereby conserving downstream computing resources that would otherwise be used to analyze such web pages.

In yet another embodiment, the aforementioned brand score is generated for a given web page by providing the goods/services information associated with the trademark and the page content of the web page to a machine learning model. The machine learning model is trained on descriptions of goods/services of registered trademarks and trademark classes associated therewith. The machine learning model identifies a measure of similarity between the goods/services information and the page content of the web page. The brand score for the web page is determined based at least in part on the measure of similarity. Such an embodiment leverages machine learning to improve the ability of the system to identify web pages that use the word(s) of the trademark as a brand.

In still another embodiment, the aforementioned commercial score is generated for a given web page by comparing elements included in the page content of the web page to a predefined set of expected commercial web page elements (e.g., an “add to cart” button, a shopping basket, a dollar sign or other symbol(s) associated with a price, certain commerce-related words or phrases), and then determining the commercial score for the web page based at least in part on the results of the comparing. Such an embodiment improves the ability of the system to identify web pages that use the word(s) of the trademark in a commercial context.

In a further embodiment, the UI manager presents the information about each web page in the plurality of web pages via the UI by ranking each web page based on the brand score and/or the commercial score associated therewith and presenting the information about each web page in an order determined by the rankings. By presenting the web pages in a ranked order in the UI, the system enables the user to easily locate the web pages that have the highest brand score and/or commercial score and are therefore most likely to include evidence of commercial use of the trademark. This feature can save a user time and can also conserve computing resources that would otherwise be expended if the user were required to browse through the web pages to find the best results.

In a still further embodiment, the web page content analyzer obtains an excerpt of text for each web page and identifies one or more words within the excerpt that contributed to the generation of the brand score and/or the commercial score for that web page. The UI manager then presents via the UI the excerpt of text from the web page with the identified word(s) highlighted. This feature can assist the user in understanding why the system assigned the web page its corresponding brand score and/or commercial score. Also, by showing the highlighted words that contributed to the score(s) in context, the system enables the user to make an independent assessment of the relevancy of the web page with respect to brand and commercial usage.

In a yet further embodiment, the web page content analyzer identifies one or more elements within the page content of each web page that contributed to the generation of the brand score and/or the commercial score for that web page and modifies the page content of the web page to highlight the identified element(s). The UI manager then renders the modified page content of the web page to the UI. This feature can also assist the user in understanding why the system assigned the web page its corresponding brand score and/or commercial score and can also enable the user to make an independent assessment of the relevancy of the web page with respect to brand and commercial usage.

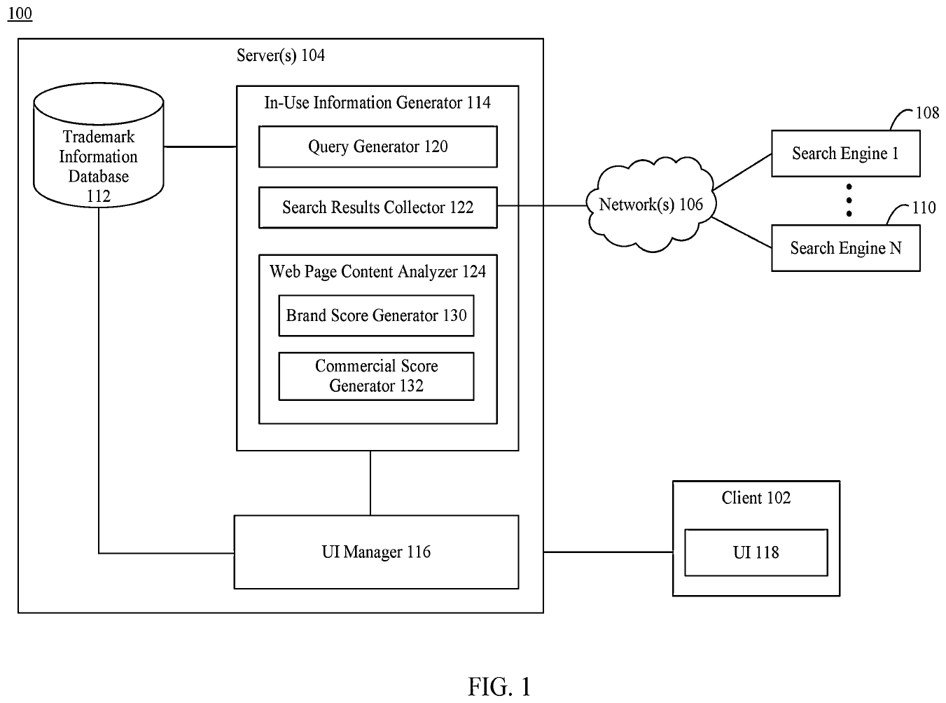

Various embodiments of systems and methods for obtaining evidence of online commercial use of a trademark that provide one or more of the foregoing features and benefits will now be described in reference to FIGS. 1-12.

In particular, FIG. 1 shows a block diagram of an example system 100 for obtaining evidence of online commercial use of a trademark in accordance with an embodiment. As shown in FIG. 1, system 100 includes a client 102, one or more servers 104, one or more network(s) 106, and search engines 108, 110.

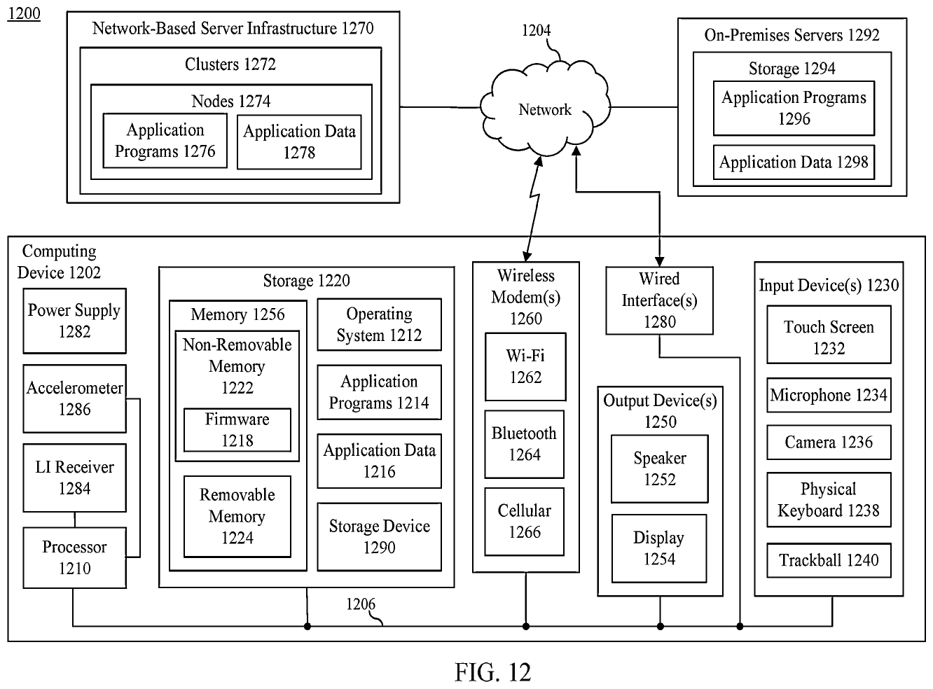

Client 102 is intended to broadly represent any computing device suitable for performing functions that are ascribed thereto in the following description, as will be appreciated by persons skilled in the relevant art(s). Various example implementations of client 102 are described below in reference to a computing device 1202 of FIG. 12. Client 102 is communicatively/operatively connected/coupled to server(s) 104. Although only a single client 102 is shown in FIG. 1 for the sake of illustration, it is to be understood that system 100 may include any number of clients, each of which is capable of communicating with server(s) 104 to invoke and/or perform functions relating to obtaining evidence of online commercial use of a trademark as will be described herein.

Server(s) 104 is intended to broadly represent any server computing device(s) that is/are suitable for performing functions that are ascribed thereto in the following description, as will be appreciated by persons skilled in the relevant art(s). With reference to the exemplary computing environment 1200 of FIG. 12 described below, server(s) 104 may be implemented as on-premises servers 1292, as part of network-based server infrastructure 1270, or both.

Network(s) 106 is intended to broadly represent any network(s) suitable for interconnecting and enabling the communication of data between various computing devices. Network(s) 106 may comprise one or more networks such as local area networks (LANs), wide area networks (WANs), enterprise networks, the Internet, etc., and may include one or more wired and/or wireless portions.

Search engines 108, 110 are intended to represent software executing on one or more corresponding computing devices (e.g., corresponding server computing device(s)) and operable to carry out searches for web pages, such as keyword-based searches for web-pages. Search engines 108, 110 may comprise, for example and without limitation, one or more publicly available Internet search engines, such as Microsoft® Bing®, Google® Search, Baidu®, Yahoo!®, Yandex®, Ask®, or DuckDuckGo®, among others. In the system of FIG. 1, server(s) 104 are communicatively/operatively connected to search engines 108, 110 via network(s) 106. Although two search engines 108, 110 are shown in FIG. 1, it is to be understood that system 100 may utilize any number of search engines depending on the implementation, including only one search engine or more than two search engines.

System 100 collectively implements one or more applications (hereinafter, application) that enables a user thereof to obtain evidence of online commercial use of a trademark. In one example, the feature pertaining to enabling the user to obtain evidence of online commercial use of a trademark comprises one of a suite of features relating to trademark research and protection provided by such application, although this example is not intended to be limiting.

In the example implementation depicted in FIG. 1, the application comprises a “front-end” component comprising at least a user-interface (UI) 118 that is executed on client 102, as well as a number of “back-end” components that are executed on server(s) 104. Client 102 is communicatively connected to server(s) 104 (e.g., via network(s) 106 or some other network(s) or peer-to-peer connection), such that these components may interact with each other. However, this is only one example implementation. For example, in an alternate implementation, all of the components of the application may execute on a single computing device. In a further alternate implementation, the distribution of components between client 102 and server(s) 104 may be different than that shown in FIG. 1.

UI 118 executing on client 102 is intended to represent an interface by which the user interacts with the application. UI 118 may operate to accept input to the application from the user and to present outputs of the application to the user. UI 118 may comprise one or more of a graphical UI (GUI), a touchscreen GUI, a menu-driven interface, a command line interface (CLI), a voice UI, a conversational UI, or the like. In some embodiments, UI 118 may be presented to the user via a browser executing on client 102. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

The “back-end” components of the application implemented on server(s) 104 include a trademark information database 112, an in-use information generator 114, and a UI manager 116.

Trademark information database 112 comprises a repository of information about trademarks stored in an organized manner in non-volatile memory across one or more storage components or devices. Trademark information database 112 may comprise, for example, a privately managed database of trademark information that includes trademark information compiled from a plurality of trademark registers across a plurality of different geographic regions and/or countries, and periodically updated. Alternatively, trademark information database 112 may comprise a publicly available database of trademark information maintained and updated, e.g., by a trademark office associated with a particular country, region or organization. Trademark information database 112 may comprise information about registered trademarks, trademarks that are pending registration, and/or trademarks for which registration has lapsed. For a given trademark, trademark information database 112 may store information such as but not limited to a trademark country, a trademark name, a trademark image (e.g., design or logo), trademark classes and subclasses, goods/services descriptions for each class, a serial number, a filing date, a registration number, a registration date, owner information, a description of mark, a type of mark, and a status of mark.

In-use information generator 114 comprises software/code that executes on server(s) 104 and operates to generate in-use information for selected trademarks about which information is stored in trademark information database 112. As will be discussed in more detail herein, such in-use information may include a list of web pages (and associated URLs) that have been determined to relate to the trademark as well as a brand score and a commercial score for each web page, wherein the brand score for a given web page is a measure of confidence that the web page includes the trademark and the commercial score for a given web page is a measure of confidence that the web page relates to commerce.

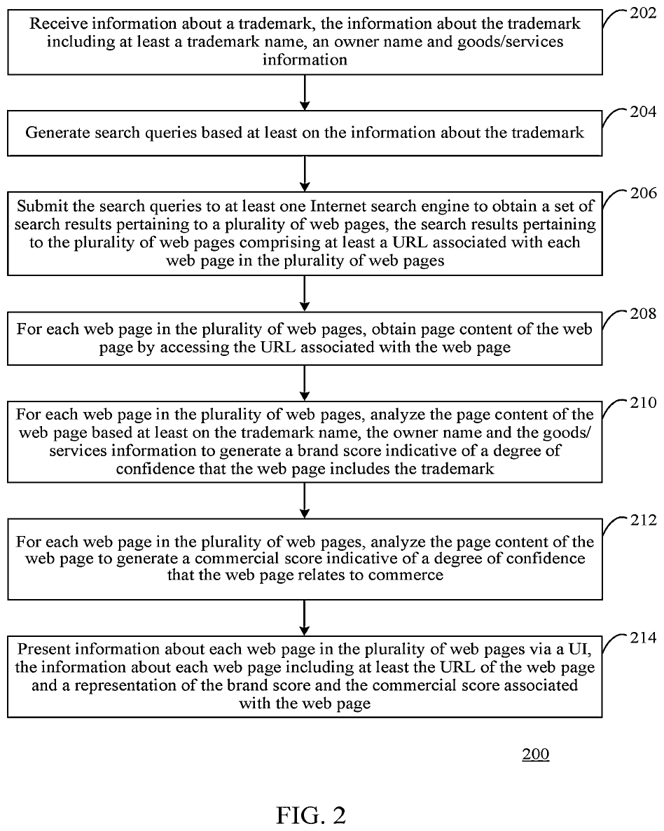

As shown in FIG. 1, in-use information generator 114 comprises a number of sub-components including a query generator 120, a search results collector 122 and a web page content analyzer 124. Furthermore, web page content analyzer 124 includes a brand score generator 130 and a commercial score generator 132. The function and manner of operation of each of these sub-components will be discussed below in reference to FIG. 2.

UI manager 116 is a component of the application that operates to receive inputs from the user via UI 118 and to invoke features of the application responsive to those inputs. UI manager 116 also operates to present outputs of the application to the user via UI 118.

For example, in an embodiment, UI manager 116 receives a request for in-use information for a particular trademark from a user via UI 118. In response to receiving the request, UI manager 116 obtains information about the particular trademark from trademark information database 112 and provides the information to in-use information generator 114 which utilizes the information to generate in-use information for the particular trademark. UI manager 116 then presents the in-use information generated by in-use information generator 114 to the user via UI 118.

In another embodiment, in-use information generator 114 is operated in an offline mode to generate in-use information from some or all of the trademarks for which information is stored in trademark information database 112 and this in-use information is then stored in trademark information database 112 or some other suitable storage means (e.g., one or more non-volatile memory systems or devices). Such stored in-use information may be periodically or intermittently updated to ensure it remains fresh. In accordance with this embodiment, when UI manager 116 receives a request for in-use information for a particular trademark from a user via UI 118, UI manager 116 may retrieve the in-use information (which was generated in advance) from storage and cause it to be presented to the user.

In a still further embodiment, system 100 utilizes a caching scheme in which in-use information generated for a particular trademark in response to a user request is stored in a cache (not shown in FIG. 1) and re-used to respond to other requests (e.g., from the same user or other users) for in-use information for the same trademark. In further accordance with such an embodiment, in-use information may be re-used so long as it is present in the cache (there is a cache hit) and marked valid. Cache entries may be invalidated and/or removed from the cache based on staleness algorithm, a first-in-first-out (FIFO) algorithm, a least frequently used (LFU) algorithm, or the like. The use of a cache in this manner can improve system performance by ensuring that system 100 does not need to re-generate in-use information for a particular trademark every time a user requests such information.

An exemplary manner in which in-use information may be generated and presented to a user will now be described in reference to FIG. 2. In particular, FIG. 2 depicts a flowchart 200 of a method for obtaining evidence of online commercial use of a trademark in accordance with an embodiment. The method of flowchart 200 may be performed, for example, by in-use information generator 114 and UI manager 116 as introduced above in reference to FIG. 1 and, for the sake of illustration, will now be described with continued reference to those components. However, the method is not limited to such an implementation and may be implemented by other entities entirely. Furthermore, the order of steps shown in flowchart 200 does not necessarily imply a strict temporal sequence and various steps may occur concurrently or in a different order than that shown.

As shown in FIG. 2, the method of flowchart 200 starts at step 202, in which information about a trademark is received, wherein the information about the trademark includes at least a trademark name, an owner name and goods/services information. This step may be performed, for example, by in-use information generator 114 which may receive the information about the trademark from trademark information database 112 or from UI manager 116. In-use information generator 114 may receive such information pursuant to honoring a user request (submitted by a user via UI 118 and received by UI manager 116) to obtain in-use information about the trademark. Alternatively, in-use information generator 114 may receive such information from trademark information database 112 pursuant to performing an “offline” generation of in-use information for the trademark as discussed above.

The trademark name may comprise one or more words that make up or are included in the trademark. The owner name may comprise the name of a business entity, organization or person that has been identified as an owner of the trademark. The good/services information may comprise one or more classes associated with the trademark, as well as text (e.g., unstructured text) describing goods or services associated with the trademark. For example, the goods/services information may comprise a goods or services description for each class with which the trademark is associated. The goods/services information may further include one or more subclasses associated with each class with which the trademark is associated.

Although step 202 indicates that the information about the trademark includes at least a trademark name, an owner name and goods/services information, such trademark information may also include additional information. For example and without limitation, such information about the trademark may further include a location (e.g., country or region) with which the trademark is associated (e.g., a country or region in which the trademark has been applied for or in which the trademark has been registered).

At step 204, search queries are generated based at least on the information about the trademark received in step 202. This step may be performed, for example, by query generator 120. In an embodiment, the search queries are automatically generated by populating one or more query templates with words extracted or otherwise derived from the information about the trademark received during step 202. The query templates may be specifically designed (e.g. and validated through experimentation) to capture web pages that use the word(s) of the trademark as a brand and/or in a commercial context. Generation of the search queries in this manner can increase the likelihood that relevant web pages are included within the scope of the search. This can also reduce the amount of computing resources that would otherwise be expended if a poorly crafted search query was used, which could result in the identification and analysis of numerous irrelevant web pages.

An example of automatic query generation based on query templates that may be used to implement step 204 will now be described. In this example, the trademark name is “clean break” and the trademark owner is “Jack Black, L.L.C.” The goods/services information associated with the trademark includes a class of “003” and a goods/services description as follows:
Facial moisturizer with SPF, skin moisturizer with SPF; skin emollient, skin lotion, skin cream, skin moisturizer, non-medicated skin care preparation; eye cream, facial lotion, facial cream, facial moisturizer, non-medicated facial skin serum, non-medicated facial skin treatment in the nature of a lotion, cream, gel or mask, facial cleansers, facial scrubs, beauty masks, facial masks, facial soaps, skin toner, skin conditioner, non-medicated skin refresher in the nature of a lotion, cream, gel or toner; bar soap, soaps for personal use, skin soaps; pre-shave cream, pre-shave oils, pre-shave facial moisturizers, after-shave lotion, after-shave balm, after-shave conditioner, after-shave facial moisturizers, after-shave preparation, shaving balm, shaving gel, shaving cream, shaving lotion, shaving soap, shaving preparation, shave oil; non-medicated skin care preparations, namely, cleansers, astringents, lotions, facial scrubs, cleansing wipes, moisturizers, acne and blemish treatment, blemish clearing patches and facial masks; non-medicated anti-blemish topical preparations in the form of serums, lotions, creams, gels and cleansers; astringents for cosmetic purposes, non-medicated astringent facial wipes and pads; cleansing facial wipes and pads.

In further accordance with this example, query generator 120 may populate different query templates with information extracted or otherwise derived from the foregoing information for the trademark “clean break” to generate a set of search queries. As will be illustrated by the following examples, a query template may specify a particular one of a plurality of different search engines, such that a search query generated using the template will be applied to the particular search engine, and such that different query templates can be used to produce search queries for different search engines. Furthermore, a query template may be generic in nature such that a search query generated therefrom will be applied to all of the web pages indexed by a search engine or may be specific in nature such that the search queries will be applied to only certain web pages indexed by a search engine. Additionally, a query template may be tied to a particular country or region, such that a search query generated therefrom will be targeted to the particular country or region.

As a first example, through application of the above-described information for the trademark “clean break” to a query template of the type “Google—Generic—TM Plus Owner—UK,” the following search query is generated:
GOOGLE|“clean break” “jack black”

This search query is directed to the Google® search engine and is not limited to any particular websites. The search query requests the identification of any web page that includes both the full trademark name “clean break” and the full owner name excluding company suffix “jack black”. It has been observed that web pages that include both these elements have an increased likelihood of demonstrating the use of the words of the trademark as a brand.

As another example, through application of the above-described information for the trademark “clean break” to a query template of the type “Google—Generic—TM Bias G/S—UK”, the following search query is generated:
GOOGLE|“clean break” (“facial moisturizer with spf” OR “skin moisturizer with spf” OR “skin emollient” OR “skin lotion” OR “skin cream” OR “skin moisturizer” OR “non-medicated skin care preparation” OR “eye cream” OR “facial lotion” OR “facial cream” OR “facial moisturizer” OR “non-medicated facial skin serum” OR “non-medicated facial skin treatment in the nature of a lotion” OR cream OR “gel or mask” OR “facial cleansers” OR “facial scrubs” OR “beauty masks” OR “facial masks” OR “facial soaps” OR “skin toner” OR “skin conditioner” OR “non-medicated skin refresher in the nature of a lotion” OR cream OR “gel or toner” OR “bar soap” OR “soaps for personal use” OR “skin soaps” OR “pre-shave cream” OR “pre-shave oils” OR “pre-shave facial moisturizers” OR “after-shave lotion” OR “after-shave balm” OR “after-shave conditioner” OR “after-shave facial moisturizers” OR “after-shave preparation” OR “shaving balm” OR “shaving gel” OR “shaving cream” OR “shaving lotion” OR “shaving soap” OR “shaving preparation” OR “shave oil” OR “non-medicated skin care preparations” OR cleansers OR astringents OR lotions OR “facial scrubs” OR “cleansing wipes” OR moisturizers OR “acne and blemish treatment” OR “blemish clearing patches and facial masks” OR “non-medicated anti-blemish topical preparations in the form of serums”)
   This search query is directed to the Google® search engine and is not limited to any particular websites. The search query requests the identification of any web page that includes both the full trademark name “clean break” and any one of the individual goods descriptions listed inside the parentheses. The individual goods descriptions listed inside the parentheses may be obtained by automatically parsing the goods/services description for the “jack black” mark. It has been observed that web pages that includes both the full trademark name and any one of the individual goods or services descriptions specified in the goods/services description of the trademark have an increased likelihood of demonstrating the use of the words of the trademark as a brand.

As yet another example, through application of the above-described information for the trademark “clean break” to a query template of the type “Google—Generic—TM—UK”, the following three search queries are generated:
GOOGLE|intitle: “clean break” OR inurl:“clean break”
GOOGLE|intitle: “clean break”
GOOGLE|“clean break”
   Each of these search queries is directed to the Google® search engine and is not limited to any particular websites. The first search query requests the identification of any web page that includes the full trademark name “clean break” in the web page title or that includes the full trademark name “clean break” in the web page URL. The second search query requests the identification of any web page that includes the full trademark name “clean break” in the web page title. The third search query requests the identification of any web page that includes the full trademark name “clean break”.

As still another example, through application of the above-described information for the trademark “clean break” to a query template of the type “Google—Industry Sites—TM—UK”, the following search query is generated:
GOOGLE|“clean break” (site:beautyoutlets.co.uk OR
site:fragrancedirect.co.uk OR site:cosmeticsbusiness.com OR
site:britishbeautyblogger.com OR site:very.co.uk OR
site:directcosmetics.com OR site:boots.com)

This search query is directed to the Google® search engine and is limited to the particular websites beautyoutlets.co.uk, fragrancedirect.co.uk, cosmeticsbusiness.com, britishbeautyblogger.com, very.co.uk, directcosmetics.com, and boots.com. The search query requests the identification of any web page within the foregoing websites that includes the full trademark name “clean break”. In an embodiment, a domain expert or other entity may determine industry websites that are relevant to a particular class of trademark goods/services. In further accordance with such an embodiment, the class associated with a trademark may be used to select such industry websites when generating a search query using a query template limited to “Industry Sites”. In this way, the search query that is generated can be targeted to those websites that are likely to reflect use of the trademark as a brand. In embodiments, a subclass and/or goods/services description associated with the trademark may alternatively or additionally be used to select the corresponding industry websites.

As still another example, through application of the above-described information for the trademark “clean break” to a query template of the type “Google—Generic—Owner—UK”, the following five search queries are generated:
GOOGLE|intitle: “jack black” OR inurl: “jack black”
GOOGLE|intitle:jack intitle:black
GOOGLE|“jack black”
GOOGLE|jack black
GOOGLE|jack black, l.l.c.
   Each of these search queries is directed to the Google® search engine and is not limited to any particular websites. The first search query requests the identification of any web page that includes the full owner name excluding company suffix “jack black” in the web page title or in the web page URL. The second search query requests the identification of any web page that includes each one of the words in the owner name excluding company suffix “jack black” in the web page title. The third search query requests the identification of any web page that includes the full owner name excluding company suffix “jack black”. The fourth search query requests the identification of any web page that includes each one of the words in the owner name excluding company suffix “jack black”. The fifth search query requests the identification of any web page that includes each one of the words and the company suffix in the owner name “jack black, l.l.c.”.

At step 206, the search queries generated during step 204 are submitted to at least one Internet search engine to obtain a set of search results pertaining to a plurality of web pages, the search results pertaining to the plurality of web pages comprising at least a URL associated with each web page in the plurality of web pages. This step may be performed, for example, by search results collector 122 which may receive the search queries generated by query generator 120 and submit them to one or more of search engines 108, 110. Each search engine to which the search queries are submitted processes the search queries and returns a corresponding set of search results to search results collector 122. The search results comprise information about a plurality of web pages that were identified by the search engine as being responsive to the search queries. For example and without limitation, the search results may comprise, for each web page in the plurality of web pages: a URL of the web page, a title of the web page, and a snippet of text extracted from the web page by the search engine. The snippet of text may comprise one or more portions of text of the web page that were selected by the search engine at least in part because such portion(s) include search terms of a search query.

At step 208, page content of each web page in the plurality of web pages is obtained by accessing the URL associated with the web page. This step may be performed, for example, by web page content analyzer 124. For example, web page content analyzer 124 may access the URL associated with each web page to obtain an HTML document that includes the full content of the web page. Note that this step may also involve rendering the retrieved HTML document (e.g., including executing JavaScript code embedded therein) to obtain a representation of the web page content as would be observed by a user in a browser.

At step 210, the page content obtained for each web page in the plurality of web pages is analyzed based at least on the trademark name, the owner name and the goods/services information to generate a brand score indicative of a degree of confidence that the corresponding web page includes the trademark (i.e., is using the trademark as a brand). This step may be performed, for example, by brand score generator 130. In an embodiment, the higher the brand score assigned to a web page by brand score generator 130, the greater the degree of confidence that the corresponding web page includes the trademark.

Brand score generator 130 may consider any of a variety of factors in determining the brand score for a given web page. For example, brand score generator 130 may increase the brand score associated with a given web page if any of the following conditions exist: (a) the page content includes the full trademark name; (b) the page content includes the full owner name (or full owner name with company suffix excluded); and (c) the page content includes or is otherwise related to a good/service included in the goods/services description for the trademark. In an embodiment, a web page satisfying some or all of these conditions may have a higher brand score than a web page satisfying a fewer number of the conditions. Moreover, different weights may be assigned to each of these factors or to different combinations of these factors. However, these are only examples, and a variety of other scoring algorithms may be used to determine the brand score for a given web page.

In an embodiment that will be discussed below with respect to FIG. 5, an algorithm or model obtained through machine learning may be used to determine a measure of similarity between the goods/services descriptions associated with the trademark and the web page content. This measure of similarity may then be used to determine the brand score for the web page.

At step 212, the page content obtained for each web page in the plurality of web pages is analyzed to generate a commercial score indicative of a degree of confidence that the corresponding web page relates to commerce. This step may be performed, for example, by commercial score generator 132. In an embodiment, the higher the commercial score assigned to a web page by commercial score generator 132, the greater the degree of confidence that the corresponding web page relates to commerce.

Commercial score generator 132 may consider any of a variety of factors in determining the commercial score for a given web page. In an embodiment, commercial score generator 132 generates a commercial score for a given web page by comparing elements included in the page content of the web page to a predefined set of expected commercial web page elements (e.g., an “add to cart” button, a shopping basket, a dollar sign or other symbol(s) associated with a price, certain commerce-related words or phrases) and then determines the commercial score for the web page based at least in part on the results of the comparing. For example, a web page that includes a certain number of such expected commercial web page elements may be assigned a higher commercial score than a web page that includes a fewer number of such elements. However, this is only an example and commercial score generator 132 may also consider alternative or additional factors in generating the commercial score. For example, in determining the commercial score, commercial score generator 132 may consider placement of commerce-related elements within the web page and proximity to other web page content (e.g., whether a commerce-related element is located next to the trademark name or a good/service associated with the trademark).

At step 214, information about each web page in the plurality of web pages is presented via a UI, the information about each web page including at least the URL of the web page and a representation of the brand score and the commercial score associated with the web page. This step may be performed, for example, by UI manager 116, which may present the information about each web page in the plurality of web pages via UI 118. In an embodiment, the URL of each web page that is presented to the user may be provided in the form of a link that may be used to navigate to the web page if the user so desires. The representation of the brand score and the commercial score for each web page may be utilized by a user to determine which of the web pages are the best candidates for providing evidence of online commercial use of the trademark. Further details concerning an example GUI implementation of UI 118 and the manner in which UI manager 116 may present the information about each web page in the plurality of web pages thereto will be provided below in reference to FIGS. 7-11.

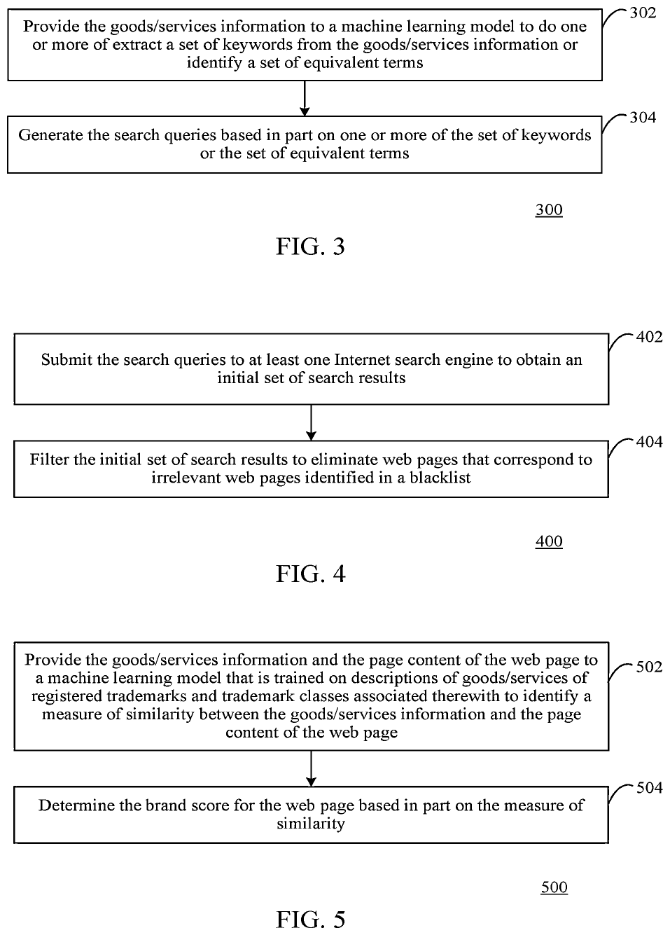

FIG. 3 depicts a flowchart 300 of a method for generating search queries for obtaining evidence of online commercial use of a trademark in accordance with an embodiment. The method of flowchart 300 may represent one manner of implementing step 204 of flowchart 200 and may be performed by query generator 120. However, the method is not limited to such an implementation and may be implemented by other entities entirely. Furthermore, the order of steps shown in flowchart 300 does not necessarily imply a strict temporal sequence and various steps may occur concurrently or in a different order than that shown.

As shown in FIG. 3, the method of flowchart 300 begins at step 302, in which the goods/services information is provided to a machine learning model to extract a set of keywords from the goods/services information or to identify a set of equivalent terms. For example, in accordance with an embodiment, a machine learning model is trained to extract keywords from the trademark goods/services description that best represent the goods/services covered by the trademark. As another example, a machine learning model is trained to identify equivalent terms to those included in the trademark goods/services description that do not themselves appear in the goods/services description for the trademark.

At step 304, the search queries are generated based in part on the set of keywords or the set of equivalent terms. For example, query generator 120 may use the keywords extracted from the goods/services description by the machine learning model to generate the search queries. Likewise, query generator 120 may use the equivalent terms identified by the machine learning model to generate the search queries. By utilizing machine learning to build search queries in the foregoing manner, embodiments may enhance the performance of the system in terms of identifying web pages that use the word(s) of the trademark as a brand and/or in a commercial context.

FIG. 4 depicts a flowchart 400 of a method for obtaining a set of search results for obtaining evidence of online commercial use of a trademark in accordance with an embodiment. The method of flowchart 400 may represent one manner of implementing step 206 of flowchart 200 and may be performed by search results collector 122. However, the method is not limited to such an implementation and may be implemented by other entities entirely. Furthermore, the order of steps shown in flowchart 400 does not necessarily imply a strict temporal sequence and various steps may occur concurrently or in a different order than that shown.

As shown in FIG. 4, the method of flowchart 400 begins at step 402, in which the search queries are submitted to at least one Internet search engine to obtain an initial set of search results. For example, search results collector 122 may submit the search queries generated by query generator 120 to search engines 108, 110 to obtain an initial set of search results.

At step 404, the initial set of search results are filtered to eliminate web pages that correspond to irrelevant web pages identified in a blacklist. For example, search results collector 122 may filter the initial set of search results to eliminate the web pages identified in the blacklist. The blacklist may be populated with web pages that are likely to be identified based on the search queries but that are also known to be irrelevant in terms of showing commercial use of trademarks (e.g., dictionary web pages, web pages with trademark listings, etc.). By removing such web pages from further analysis, this technique advantageously conserves downstream computing resources that would otherwise be used to analyze such web pages.

FIG. 5 depicts a flowchart 500 of a method for generating a brand score for a web page in accordance with an embodiment. The method of flowchart 500 may represent one manner of implementing step 210 of flowchart 200 and may be performed by brand score generator 130. However, the method is not limited to such an implementation and may be implemented by other entities entirely. Furthermore, the order of steps shown in flowchart 500 does not necessarily imply a strict temporal sequence and various steps may occur concurrently or in a different order than that shown.

As shown in FIG. 5, the method of flowchart 500 begins at step 502, in which the goods/services information and the page content of the web page are provided to a machine learning model that is trained on descriptions of goods/services of registered trademarks and trademark classes associated therewith to identify a measure of similarity between the goods/services information and the page content of the web page. For example, a goods/services similarity engine may be trained on a corpus of training data that includes the descriptions of goods/services for registered trademarks and trademark classes associated with such descriptions of goods/services in the manner described in U.S. Pat. No. 10,565,533 to Keyngnaert et al. (the entirety of which is incorporated by reference herein). Such goods/services similarity engine can then be used by brand score generator 130 to identify similarities between the goods/services description for a trademark and the page content of a web page (e.g., preprocessed to extract text therefrom) and generate a measure of similarity between the two.

At step 504, the brand score for the web page is determined based in part on the measure of similarity. For example, brand score generator 130 may use the measure of similarity generated during step 502 as a factor in determining the overall brand score for the web page. For example, in an embodiment, the higher the measure of similarity between the goods/services information and the page content of the web page, the higher the brand score for the web page. The foregoing embodiment of FIG. 5 advantageously leverages machine learning to improve the ability of the system to identify web pages that use the word(s) of the trademark as a brand.

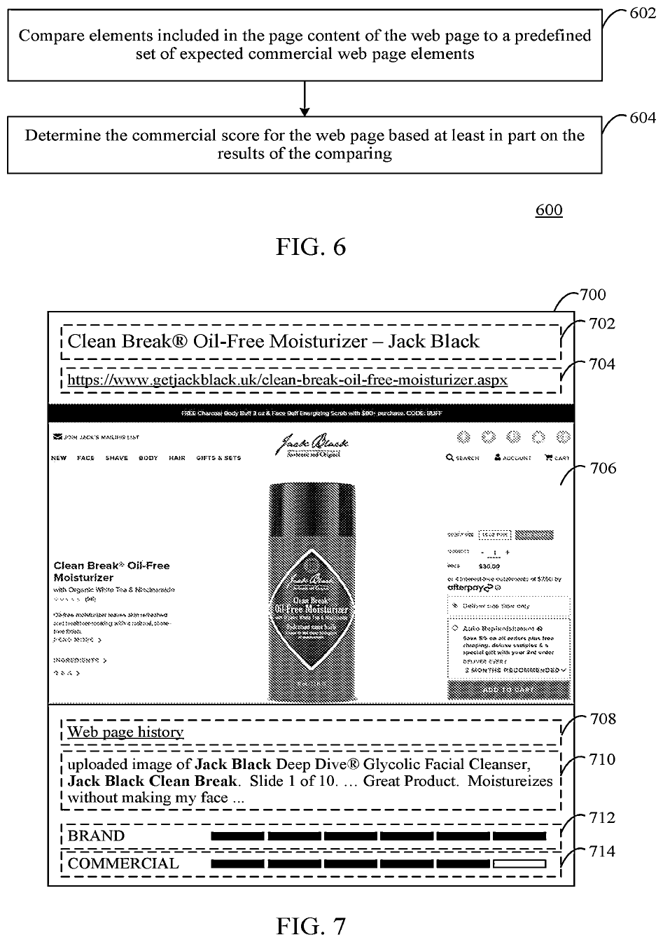

FIG. 6 depicts a flowchart 600 of a method for generating a commercial score for a web page in accordance with an embodiment. The method of flowchart 600 may represent one manner of implementing step 212 of flowchart 200 and may be performed by commercial score generator 132. However, the method is not limited to such an implementation and may be implemented by other entities entirely. Furthermore, the order of steps shown in flowchart 600 does not necessarily imply a strict temporal sequence and various steps may occur concurrently or in a different order than that shown.

As shown in FIG. 6, the method of flowchart 600 begins at step 602, in which elements included in the page content of the web page are compared to a predefined set of expected commercial web page elements. Thus, as was previously discussed, commercial score generator 132 may compare elements included in the page content of the web page to a predefined set of expected commercial web page elements (e.g., an “add to cart” button, a shopping basket, a dollar sign or other symbol(s) associated with a price, certain commerce-related words or phrases).

At step 604, the commercial score for the web page is determined based at least in part on the results of the comparing. Thus, as was also previously discussed, commercial score generator 132 may generate the commercial score for the web page based on whether any such expected commercial web page elements appear within the page content of the web page. Commercial score generator 132 may further consider how many of such elements appear in the web page and the context in which they appear.

FIG. 7 shows an example UI element 700 via which information about a web page may be presented to a user in a system for obtaining evidence of online commercial use of a trademark in accordance with an embodiment. For example, UI manager 116 may present UI element 700 to UI 118 during step 214 of flowchart 200. UI manager 116 may present one such UI element for each web page about which information is presented in step 214. UI element 700 may also be referred to herein as a “web page tile.” As shown in FIG. 7, example UI element 700 includes a web page title 702, a web page URL 704, a web page snapshot 706, a web page history link 708, a web page snippet 710, a brand score representation 712 and a commercial score representation 714.

Web page title 702 is a representation of the title of the web page associated with UI element 700.

Web page URL 704 is a URL for the web page associated with UI element 700. In an embodiment, a user may click on or otherwise interact with the URL to navigate to the web page.

Web page snapshot 706 is a graphical representation of a portion of the web page associated with UI element 700. In an embodiment, UI manager 116 generates web page snapshot 706 by rendering at least a portion of the page content (e.g., HTML content, embedded JavaScript code) of the web page that was obtained during step 208 of flowchart 200.

Web page history link 708 comprises a link that a user may click on or otherwise interact with to access a web page archive via which the user can view previously saved versions of the web page associated with UI element 700. For example, the link may enable the user to access previously saved versions of the web page via a publicly-available Internet archive such as Wayback Machine®, although this is only an example and any suitable web page archive may be used. This feature helps the user observe how the web page may have changed over time and, in the context of commercial use of a trademark, potentially determine how long a commercial use of a trademark has continued over time.

Web page snippet 710 comprises text that has been selectively extracted from the web page associated with UI element 700. In an embodiment, web page snippet 710 comprises a snippet that was returned by a search engine (e.g., one of search engines 108, 110) during step 206 of flowchart 200 as part of the search results that identified the web page. Alternatively, web page snippet 710 may be selectively extracted from the page content of the web page by web page content analyzer 124. More details concerning the generation of web page snippet 710 and the selective highlighting of text included therein will be discussed in reference to FIG. 10 below.

Brand score representation 712 is a representation of the brand score determined by brand score generator 130 for the web page associated with UI element 700. As shown in FIG. 7, brand score representation 712 represents the brand score via a bar graph comprising a line of six slots, wherein the number of slots that are filled starting from the left is indicative of the magnitude of the brand score. However, any type of representation of the brand score may be used depending on the implementation, including any of a wide variety of graphical or numerical representations.

Commercial score representation 714 is a representation of the commercial score determined by commercial score generator 132 for the web page associated with UI element 700. As shown in FIG. 7, commercial score representation 714 represents the commercial score via a bar graph comprising a line of six slots, wherein the number of slots that are filled starting from the left is indicative of the magnitude of the commercial score. However, any type of representation of the commercial score may be used depending on the implementation, including any of a wide variety of graphical or numerical representations.

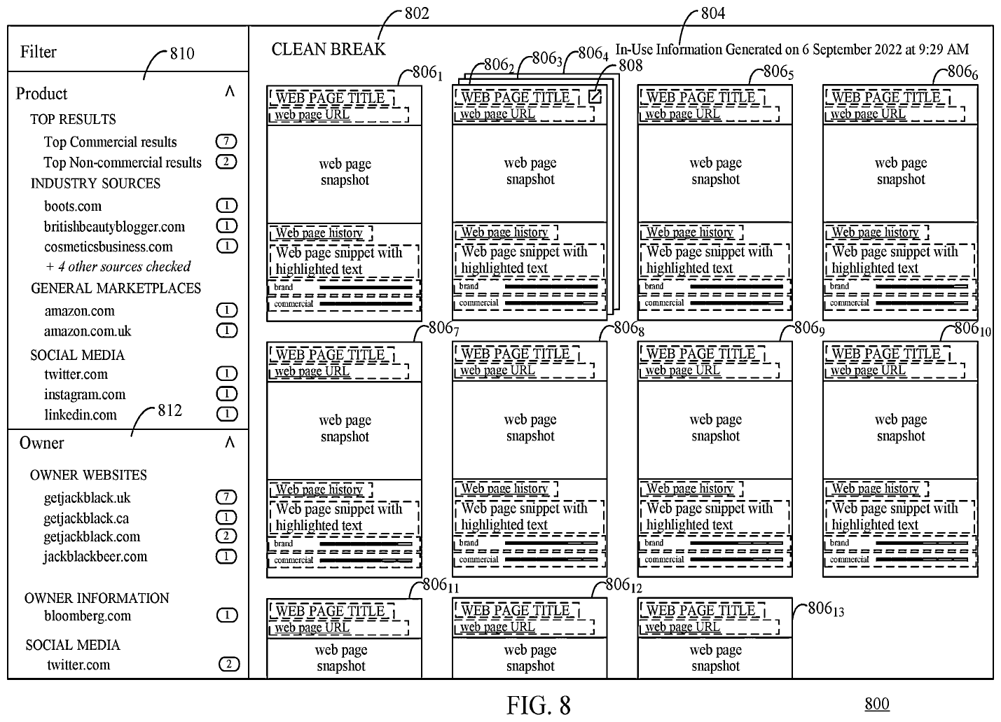

FIG. 8 shows an example UI 800 via which information about multiple web pages may be presented to a user in a system for obtaining evidence of online commercial use of a trademark in accordance with an embodiment. For example, UI manager 116 may present UI 800 to UI 118 during step 214 of flowchart 200. As shown in FIG. 8, example UI 800 includes a trademark name 802, an in-use information generation date/time 804, a plurality of web page tiles 806₁-806₁₃, a web page tile expander 808, a set of product filters 810, and a set of owner filters 812.

Trademark name 802 is a representation of the name of the trademark about which in-use information was generated.

In-use information generation date/time 804 is a representation of the date and time at which the in-use information being displayed in UI 800 was generated.

Web page tiles 806₁-806₁₃ are UI elements corresponding to the web pages about which information is being presented via UI 800. As shown in FIG. 8, each web page tile may contain the same information elements as those that were described above in reference example UI element 700 of FIG. 7—namely, a web page title, a web page URL, a web page snapshot, a web page history link, a web page snippet, a brand score representation and a commercial score representation.

In an embodiment, the web page tiles are presented in a ranked order within UI 800. For example, in the embodiment shown in FIG. 8, the web page tiles are ranked in the order of highest combined brand and commercial score to lowest combined brand and commercial score. Still other ranking methods may be used (e.g., ranked by brand score only, ranked by commercial score only). In an embodiment, UI 800 may enable the user to select from among a plurality of different ranking schemes, and the ordering of the web page tiles within UI 800 may be adjusted accordingly. By presenting the web page tiles in a ranked order in UI 800, system 100 enables the user to easily locate the web pages that have the highest brand score and/or commercial score and are therefore most likely to include evidence of commercial use of the trademark. This feature can save a user time and can also conserve computing resources that would otherwise be expended if the user were required to browse through the web pages to find the best results.

In a further embodiment, web page tiles for web pages that originate from the same domain (i.e., are part of the same website) may be stacked within GUI 800 for user convenience. A GUI control may be provided, and the user may interact with such GUI control to cause each web page tile within the stack to be displayed in an overlay on GUI 800. For example, as shown in FIG. 8, web page tiles 806₂, 806₃, and 806₄ are all from the same domain and thus are stacked one on top of the other. A web page tile expander 808 is provided on top web page tile 806₂. If a user clicks on or otherwise interacts with web page tile expander 808, each of web page 806₂, 806₃, and 806₄ may be presented in a side-by-side fashion in an overlay for visual inspection by the user until the user closes the overlay. When web page tiles are stacked in this manner, the web page tile in the stack having the highest combined brand and commercial score may be placed on top of the stack and the placement of the stack in an ordered ranking within GUI 800 may be based on this score.

Product filters 810 enable the user to select different product-related filters to view corresponding filtered subsets of the web page tiles. As shown in FIG. 8, such product-related filters may include top results filters, industry sources filters, general marketplaces filters and social media filters.

Top results filters include a top commercial results filter and a top non-commercial results filter. User selection of the top commercial results filter causes UI manager 116 to display within UI 800 only those web tiles that represent web pages having both a high brand score (e.g., a brand score that exceeds a certain threshold) and a high commercial score (e.g., a commercial score that exceeds a certain threshold). User selection of the top non-commercial results filter causes UI manager 116 to display within UI 800 only those web tiles that represent web pages having both a high brand score (e.g., a brand score that exceeds a certain threshold) and a low commercial score (e.g., a commercial score that is below a certain threshold).

Industry sources filters include filters for different industry websites that are relevant to the class(es) of goods/services associated with the trademark for which in-use information is being generated. These industry websites may be determined by a domain expert and may be the same as those used to generate “industry sites” search queries as discussed above in reference to step 204 of flowchart 200. As shown in the specific example of FIG. 8, the industry sources filters include a filter for each of boots.com, britishbeautyblogger.com, cosmeticsbusiness.com, and four others. User selection of an industry sources filter causes UI manager 116 to display within UI 800 only those web tiles that represent web pages within the particular web site (e.g., user selection of the “boots.com” industry sources filter causes UI manager 116 to display within UI 800 only those web tiles that represent web pages within the “boots.com” domain).

General marketplaces filters include filters for different general e-commerce websites. As shown in the specific example of FIG. 8, the general marketplaces filters include a filter for each of amazon.com and amazon.com.uk. User selection of a general marketplaces filter causes UI manager 116 to display within UI 800 only those web tiles that represent web pages within the particular e-commerce web site (e.g., user selection of the “amazon.com” general marketplaces filter causes UI manager 116 to display within UI 800 only those web tiles that represent web pages within the “amazon.com” domain).

Social media filters include filters for different social media websites. As shown in the specific example of FIG. 8, the social media filters include a filter for each of twitter.com, instagram.com and linkedin.com. User selection of a social media filter causes UI manager 116 to display within UI 800 only those web tiles that represent web pages within the particular social media website (e.g., user selection of the “twitter.com” social media filter causes UI manager 116 to display within UI 800 only web tiles that represent web pages within the “twitter.com” domain).

Owner filters 812 enable the user to select different owner-related filters to view corresponding filtered subsets of the web page tiles. As shown in FIG. 8, such owner-related filters may include owner websites filters, owner information filters, and social media filters.

Owner websites filters include filters for different websites that have been determined to include information about the trademark owner (e.g., in the website URL, title, and/or page content). As shown in the specific example of FIG. 8, the owner websites filters include a filter for each of getjackblack.uk, getjackblack.ca, getjackblack.com, imdb.com, and jackblackbeer.com. User selection of an owner websites filter causes UI manager 116 to display within UI 800 only those web tiles that represent web pages within the particular owner website (e.g., user selection of the “getjackblack.uk” owner website filter causes UI manager 116 to display within UI 800 only those web tiles that represent web pages within the “getjackblack.uk” domain).

Owner information filters include filters for different websites that are known to include company information and also include information about the trademark owner. As shown in the specific example of FIG. 8, the owner information filters include a filter for bloomberg.com. User selection of an owner information filter causes UI manager 116 to display within UI 800 only those web tiles that represent web pages within the particular web site (e.g., user selection of the “bloomberg.com” owner information filter causes UI manager 116 to display within UI 800 only those web tiles that represent web pages within the “bloomberg.com” domain).

Social media filters include filters for different social media websites. As shown in the specific example of FIG. 8, the social media filters include a filter for twitter.com. User selection of a social media filter causes UI manager 116 to display within UI 800 only those web tiles that represent web pages within the particular social media web site (e.g., user selection of the “twitter.com” social media filter causes UI manager 116 to display within UI 800 only those web tiles that represent web pages within the “twitter.com” domain).

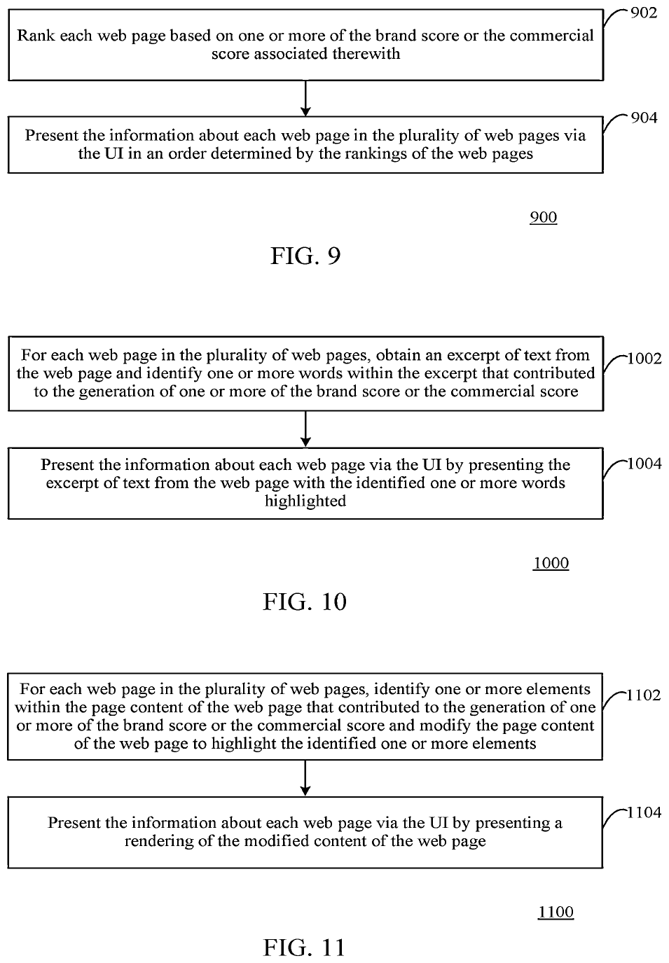

FIG. 9 depicts a flowchart 900 of a method for presenting an ordered view of information about multiple web pages identified by a system for obtaining evidence of online commercial use of a trademark in accordance with an embodiment. The method of flowchart 900 may represent one manner of implementing step 214 of flowchart 200 and may be performed by UI manager 116. However, the method is not limited to such an implementation and may be implemented by other entities entirely. Furthermore, the order of steps shown in flowchart 900 does not necessarily imply a strict temporal sequence and various steps may occur concurrently or in a different order than that shown.

As shown in FIG. 9, the method of flowchart 900 begins at step 902 in which each web page is ranked based on one or more of the brand score or the commercial score associated therewith. For example, as discussed above, UI manager 116 may rank each web page based on one or more of the brand score or the commercial score associated therewith.

At step 902, the information about each web page in the plurality of web pages is presented via the UI in an order determined by the rankings of the web pages. For example, as discussed above, UI manager 116 may present the information about each web page in the plurality of web pages via UI 118 in an order determined by the rankings of the web pages. In the specific example of GUI 800 of FIG. 8, this is achieved by ordering the web page tiles associated with each web page in accordance with a ranking based on combined brand and commercial score.

FIG. 10 depicts a flowchart 1000 of a method for presenting an excerpt of text from a web page with text that contributed to one or more of a brand score or a commercial score for the web page highlighted therein in accordance with an example embodiment. The method of flowchart 1000 may be performed by web page content analyzer 124 and UI manager 116. However, the method is not limited to such an implementation and may be implemented by other entities entirely. Furthermore, the order of steps shown in flowchart 1000 does not necessarily imply a strict temporal sequence and various steps may occur concurrently or in a different order than that shown.

As shown in FIG. 10, the method of flowchart 1000 begins at step 1002 in which, for each web page in the plurality of web pages, an excerpt of text is obtained from the web page and one or more words within the excerpt are identified that contributed to the generation of one or more of the brand score or the commercial score. For example, web page content analyzer 124 may obtain the excerpt of text from a snippet included with search results obtained by search results collector 122 or may create its own excerpt of text based on its analysis of the page content of the web page. Web page content analyzer 124 may further identify one or more words within the excerpt that contributed to the generation of one or more of the brand score or the commercial score for the web page. For example, if the owner name appears within the excerpt and contributed to the generation of the brand score, then web page content analyzer 124 may identify the owner name within the excerpt. Likewise, if a commercial term appears within the excerpt and contributed to the generation of the commercial score, then web page content analyzer 124 may identify the commercial term within the excerpt.

At step 1004, the information about each web page is presented via the UI by presenting the excerpt of text from the web page with the identified one or more words highlighted. For example, UI manager 116 may present the excerpt of text as a web page snippet within the web page tile for the web page in UI 118 and highlight the one or more words that were identified during step 1002. Thus, continuing the above example, the excerpt may be presented as part of the web page tile and within the excerpt the owner name may be highlighted (because it contributed to the brand score for the web page) and the commercial term may be highlighted (because it contributed to the commercial score for the web page). In one embodiment, when the user hovers over the representation of the brand score in the web page tile, the words in the excerpt that contributed to the brand score are highlighted and when the user hovers over the representation of the commercial score in the web page tile, the words in the excerpt that contributed to the commercial score are highlighted. Highlighting in this context may include, for example and without limitation, bolding, underlining, showing in a distinct color, or the like.

Such an embodiment can assist the user in understanding why system 100 assigned the web page its corresponding brand score and/or commercial score. Also, by showing the highlighted words that contributed to the score(s) in context within the snippet, system 100 enables the user to make an independent assessment of the relevancy of the web page with respect to brand and commercial usage.

FIG. 11 depicts a flowchart of a method for presenting a rendering of a web page with elements that contributed to one or more of a brand score or a commercial score for the web page highlighted therein in accordance with an example embodiment. The method of flowchart 1100 may be performed by web page content analyzer 124 and UI manager 116. However, the method is not limited to such an implementation and may be implemented by other entities entirely. Furthermore, the order of steps shown in flowchart 1100 does not necessarily imply a strict temporal sequence and various steps may occur concurrently or in a different order than that shown.

As shown in FIG. 11, the method of flowchart 1100 begins at step 1102 in which, for each web page in the plurality of web pages, one or more elements within the page content of the web page are identified that contributed to the generation of one or more of the brand score or the commercial score and the page content of the web page is modified to highlight the identified one or more elements. For example, web page content analyzer 124 may identify one or more elements (e.g., text elements, graphical elements, or other elements) within the page content of the web page that contributed to the generation of one or more of the brand score or the commercial score for the web page. For example, if the owner name appears within the page content and contributed to the generation of the brand score, then web page content analyzer 124 may identify the owner name within the page content and then modify the page content to highlight the owner name (e.g., by modifying HTML of the web page to highlight the owner name). Likewise, if a shopping cart appears within the page content and contributed to the generation of the commercial score, then web page content analyzer 124 may identify the shopping cart within the page content and then modify the page content to highlight the shopping cart (e.g., by modifying HTML of the web page to highlight the shopping cart).

At step 1004, the information about each web page is presented via the UI by presenting a rendering of the modified content of the web page. For example, UI manager 116 may render the modified content of the web page (or a portion thereof) to generate the web page snapshot included within a web page tile for the web page in UI 118. Since the modified content of the web page is rendered to UI 118, the web page snapshot will show the one or more elements identified during step 1102 in a highlighted form. Thus, continuing the above example, the web page snapshot included in the web page tile may show the owner name highlighted (because it contributed to the brand score for the web page) and the shopping cart highlighted (because it contributed to the commercial score for the web page). In one embodiment, when the user hovers over the representation of the brand score in the web page tile, the elements in the web page snapshot that contributed to the brand score are highlighted and when the user hovers over the representation of the commercial score in the web page tile, the elements in the web page snapshot that contributed to the commercial score are highlighted.

Such an embodiment can also assist the user in understanding why system 100 assigned the web page its corresponding brand score and/or commercial score. Also, by showing the highlighted words that contributed to the score(s) in context within the snapshot, system 100 enables the user to make an independent assessment of the relevancy of the web page with respect to brand and commercial usage.

### III. Example Mobile Device and Computer System Implementation

The components of system 100 of FIG. 1, the steps of the flowcharts of FIGS. 2-6 and 9-11, UI element 700 of FIG. 7 and UI 800 of FIG. 8 may each be implemented in hardware, or hardware combined with one or both of software and/or firmware. For example, the components of system 100 of FIG. 1, the steps of the flowcharts of FIGS. 2-6 and 9-11, UI element 700 of FIG. 7 and UI 800 of FIG. 8 may each be implemented as computer program code/instructions configured to be executed in one or more processors and stored in a computer readable storage medium. Alternatively, the components of system 100 of FIG. 1, the steps of the flowcharts of FIGS. 2-6 and 9-11, UI element 700 of FIG. 7 and UI 800 of FIG. 8 may each be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 12. FIG. 12 shows a block diagram of an exemplary computing environment 1200 that includes a computing device 1202. In some embodiments, computing device 1202 is communicatively coupled with devices (not shown in FIG. 12) external to computing environment 1200 via a network 1204. Network 1204 comprises one or more networks such as local area networks (LANs), wide area networks (WANs), enterprise networks, the Internet, etc., and may include one or more wired and/or wireless portions. Network 1204 may additionally or alternatively include a cellular network for cellular communications. Computing device 1202 is described in detail as follows.

Computing device 1202 can be any of a variety of types of computing devices. For example, computing device 1202 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 1202 may alternatively be a stationary computing device such as a desktop computer, a personal computer (PC), a stationary server device, a minicomputer, a mainframe, a supercomputer, etc.

As shown in FIG. 12, computing device 1202 includes a variety of hardware and software components, including a processor 1210, a storage 1220, one or more input devices 1230, one or more output devices 1250, one or more wireless modems 1260, one or more wired interface(s) 1280, a power supply 1282, a location information (LI) receiver 1284, and an accelerometer 1286. Storage 1220 includes memory 1256, which includes non-removable memory 1222 and removable memory 1224, and a storage device 1290. Storage 1220 also stores an operating system 1212, application programs 1214, and application data 1216. Wireless modem(s) 1260 include a Wi-Fi modem 1262, a Bluetooth modem 1264, and a cellular modem 1266. Output device(s) 1250 includes a speaker 1252 and a display 1254. Input device(s) 1230 includes a touch screen 1232, a microphone 1234, a camera 1236, a physical keyboard 1238, and a trackball 1240. Not all components of computing device 1202 shown in FIG. 12 are present in all embodiments, additional components not shown may be present, and any combination of the components may be present in a particular embodiment. These components of computing device 1202 are described as follows.

A single processor 1210 (e.g., central processing unit (CPU), microcontroller, a microprocessor, signal processor, ASIC (application specific integrated circuit), and/or other physical hardware processor circuit) or multiple processors 1210 may be present in computing device 1202 for performing such tasks as program execution, signal coding, data processing, input/output processing, power control, and/or other functions. Processor 1210 may be a single-core or multi-core processor, and each processor core may be single-threaded or multithreaded (to provide multiple threads of execution concurrently). Processor 1210 is configured to execute program code stored in a computer readable medium, such as program code of operating system 1212 and application programs 1214 stored in storage 1220. Operating system 1212 controls the allocation and usage of the components of computing device 1202 and provides support for one or more application programs 1214 (also referred to as “applications” or “apps”). Application programs 1214 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 1202 can communicate with any other component according to function, although not all connections are shown for ease of illustration. For instance, as shown in FIG. 12, bus 1206 is a multiple signal line communication medium (e.g., conductive traces in silicon, metal traces along a motherboard, wires, etc.) that may be present to communicatively couple processor 1210 to various other components of computing device 1202, although in other embodiments, an alternative bus, further buses, and/or one or more individual signal lines may be present to communicatively couple components. Bus 1206 represents one or more of any of several types of bus structures, including a memory bus or memory controller, a peripheral bus, an accelerated graphics port, and a processor or local bus using any of a variety of bus architectures.

Storage 1220 is physical storage that includes one or both of memory 1256 and storage device 1290, which store operating system 1212, application programs 1214, and application data 1216 according to any distribution. Non-removable memory 1222 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 1222 may include main memory and may be separate from or fabricated in a same integrated circuit as processor 1210. As shown in FIG. 12, non-removable memory 1222 stores firmware 1218, which may be present to provide low-level control of hardware. Examples of firmware 1218 include BIOS (Basic Input/Output System, such as on personal computers) and boot firmware (e.g., on smart phones). Removable memory 1224 may be inserted into a receptacle of or otherwise coupled to computing device 1202 and can be removed by a user from computing device 1202. Removable memory 1224 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 1290 may be present that are internal and/or external to a housing of computing device 1202 and may or may not be removable. Examples of storage device 1290 include a hard disk drive, a SSD, a thumb drive (e.g., a USB (Universal Serial Bus) flash drive), or other physical storage device.

One or more programs may be stored in storage 1220. Such programs include operating system 1212, one or more application programs 1214, and other program modules and program data. Examples of such application programs may include, for example, computer program logic (e.g., computer program code/instructions) for implementing one or more of in-use information generator 114, UI manager 116, UI 118, query generator 120, search results collector 122, web page content analyzer 124, brand score generator 130, commercial score generator 132, UI element 700, UI 800, as well as any of the steps of the flowcharts of FIGS. 2-6 and 9-11.

Storage 1220 also stores data used and/or generated by operating system 1212 and application programs 1214 as application data 1216. Examples of application data 1216 include web pages, text, images, tables, sound files, video data, and other data, which may also be sent to and/or received from one or more network servers or other devices via one or more wired or wireless networks. Storage 1220 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 1202 through one or more input devices 1230 and may receive information from computing device 1202 through one or more output devices 1250. Input device(s) 1230 may include one or more of touch screen 1232, microphone 1234, camera 1236, physical keyboard 1238 and/or trackball 1240 and output device(s) 1250 may include one or more of speaker 1252 and display 1254. Each of input device(s) 1230 and output device(s) 1250 may be integral to computing device 1202 (e.g., built into a housing of computing device 1202) or external to computing device 1202 (e.g., communicatively coupled wired or wirelessly to computing device 1202 via wired interface(s) 1280 and/or wireless modem(s) 1260). Further input devices 1230 (not shown) can include a Natural UI (NUI), a pointing device (computer mouse), a joystick, a video game controller, a scanner, a touch pad, a stylus pen, a voice recognition system to receive voice input, a gesture recognition system to receive gesture input, or the like. Other output devices (not shown) can include piezoelectric or other haptic output devices. Some devices can serve more than one input/output function. For instance, display 1254 may display information, as well as operating as touch screen 1232 by receiving user commands and/or other information (e.g., by touch, finger gestures, virtual keyboard, etc.) as a UI. Any number of each type of input device(s) 1230 and output device(s) 1250 may be present, including multiple microphones 1234, multiple cameras 1236, multiple speakers 1252, and/or multiple displays 1254.

One or more wireless modems 1260 can be coupled to antenna(s) (not shown) of computing device 1202 and can support two-way communications between processor 1210 and devices external to computing device 1202 through network 1204, as would be understood to persons skilled in the relevant art(s). Wireless modem 1260 is shown generically and can include a cellular modem 1266 for communicating with one or more cellular networks, such as a GSM network for data and voice communications within a single cellular network, between cellular networks, or between the mobile device and a public switched telephone network (PSTN). Wireless modem 1260 may also or alternatively include other radio-based modem types, such as a Bluetooth modem 1264 (also referred to as a “Bluetooth device”) and/or Wi-Fi 1262 modem (also referred to as an “wireless adaptor”). Wi-Fi modem 1262 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 1264 is configured to communicate with another Bluetooth-capable device according to the Bluetooth short-range wireless technology standard(s) such as IEEE 802.15.1 and/or managed by the Bluetooth Special Interest Group (SIG).

Computing device 1202 can further include power supply 1282, LI receiver 1284, accelerometer 1286, and/or one or more wired interfaces 1280. Example wired interfaces 1280 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 1280 of computing device 1202 provide for wired connections between computing device 1202 and network 1204, or between computing device 1202 and one or more devices/peripherals when such devices/peripherals are external to computing device 1202 (e.g., a pointing device, display 1254, speaker 1252, camera 1236, physical keyboard 1238, etc.). Power supply 1282 is configured to supply power to each of the components of computing device 1202 and may receive power from a battery internal to computing device 1202, and/or from a power cord plugged into a power port of computing device 1202 (e.g., a USB port, an A/C power port). LI receiver 1284 may be used for location determination of computing device 1202 and may include a satellite navigation receiver such as a Global Positioning System (GPS) receiver or may include other type of location determiner configured to determine location of computing device 1202 based on received information (e.g., using cell tower triangulation, etc.). Accelerometer 1286 may be present to determine an orientation of computing device 1202.

Note that the illustrated components of computing device 1202 are not required or all-inclusive, and fewer or greater numbers of components may be present as would be recognized by one skilled in the art. For example, computing device 1202 may also include one or more of a gyroscope, barometer, proximity sensor, ambient light sensor, digital compass, etc. Processor 1210 and memory 1256 may be co-located in a same semiconductor device package, such as being included together in an integrated circuit chip, FPGA, or system-on-chip (SOC), optionally along with further components of computing device 1202.

In embodiments, computing device 1202 is configured to implement any of the above-described features of flowcharts herein. Computer program logic for performing any of the operations, steps, and/or functions described herein may be stored in storage 1220 and executed by processor 1210.

In some embodiments, server infrastructure 1270 may be present in computing environment 1200 and may be communicatively coupled with computing device 1202 via network 1204. Server infrastructure 1270, when present, may be a network-accessible server set (e.g., a cloud-based environment or platform). As shown in FIG. 12, server infrastructure 1270 includes clusters 1272. Each of clusters 1272 may comprise a group of one or more compute nodes and/or a group of one or more storage nodes. For example, as shown in FIG. 12, cluster 1272 includes nodes 1274. Each of nodes 1274 are accessible via network 1204 (e.g., in a “cloud-based” embodiment) to build, deploy, and manage applications and services. Any of nodes 1274 may be a storage node that comprises a plurality of physical storage disks, SSDs, and/or other physical storage devices that are accessible via network 1204 and are configured to store data associated with the applications and services managed by nodes 1274. For example, as shown in FIG. 12, nodes 1274 may store application data 1278.

Each of nodes 1274 may, as a compute node, comprise one or more server computers, server systems, and/or computing devices. For instance, a node 1274 may include one or more of the components of computing device 1202 disclosed herein. Each of nodes 1274 may be configured to execute one or more software applications (or “applications”) and/or services and/or manage hardware resources (e.g., processors, memory, etc.), which may be utilized by users (e.g., customers) of the network-accessible server set. For example, as shown in FIG. 12, nodes 1274 may operate application programs 1276. In an implementation, a node of nodes 1274 may operate or comprise one or more virtual machines, with each virtual machine emulating a system architecture (e.g., an operating system), in an isolated manner, upon which applications such as application programs 1276 may be executed.

In an embodiment, one or more of clusters 1272 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 1272 may be a datacenter in a distributed collection of datacenters. In embodiments, exemplary computing environment 1200 comprises part of a cloud-based platform such as Amazon Web Services® of Amazon Web Services, Inc. or Google Cloud Platform™ of Google LLC, although these are only examples and are not intended to be limiting.

In an embodiment, computing device 1202 may access application programs 1276 for execution in any manner, such as by a client application and/or a browser at computing device 1202. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 1202 may additionally and/or alternatively synchronize copies of application programs 1214 and/or application data 1216 to be stored at network-based server infrastructure 1270 as application programs 1276 and/or application data 1278. For instance, operating system 1212 and/or application programs 1214 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 1220 at network-based server infrastructure 1270.

In some embodiments, on-premises servers 1292 may be present in computing environment 1200 and may be communicatively coupled with computing device 1202 via network 1204. On-premises servers 1292, when present, are hosted within an organization's infrastructure and, in many cases, physically onsite of a facility of that organization. On-premises servers 1292 are controlled, administered, and maintained by IT (Information Technology) personnel of the organization or an IT partner to the organization. Application data 1298 may be shared by on-premises servers 1292 between computing devices of the organization, including computing device 1202 (when part of an organization) through a local network of the organization, and/or through further networks accessible to the organization (including the Internet). Furthermore, on-premises servers 1292 may serve applications such as application programs 1296 to the computing devices of the organization, including computing device 1202. Accordingly, on-premises servers 1292 may include storage 1294 (which includes one or more physical storage devices such as storage disks and/or SSDs) for storage of application programs 1296 and application data 1298 and may include one or more processors for execution of application programs 1296. Still further, computing device 1202 may be configured to synchronize copies of application programs 1214 and/or application data 1216 for backup storage at on-premises servers 1292 as application programs 1296 and/or application data 1298.

Embodiments described herein may be implemented in one or more of computing device 1202, network-based server infrastructure 1270, and on-premises servers 1292. For example, in some embodiments, computing device 1202 may be used to implement systems, clients, or devices, or components/subcomponents thereof, disclosed elsewhere herein. In other embodiments, a combination of computing device 1202, network-based server infrastructure 1270, and/or on-premises servers 1292 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1214) may be stored in storage 1220. Such computer programs may also be received via wired interface(s) 1280 and/or wireless modem(s) 1260 over network 1204. Such computer programs, when executed or loaded by an application, enable computing device 1202 to implement features of embodiments discussed herein. Accordingly, such computer programs represent controllers of the computing device 1202.

Embodiments are also directed to computer program products comprising computer code or instructions stored on any computer-readable medium or computer-readable storage medium. Such computer program products include the physical storage of storage 1220 as well as further physical storage types.

### IV. Conclusion

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computer-implemented method for obtaining evidence of online commercial use of a trademark, comprising:
receiving information about the trademark, the information about the trademark including at least a trademark name, an owner name and goods/services information;
generating search queries based at least on the information about the trademark;
submitting the search queries to at least one Internet search engine to obtain a set of search results pertaining to a plurality of web pages, the search results pertaining to the plurality of web pages comprising at least a Uniform Resource Locator (URL) associated with each web page in the plurality of web pages;
for each web page in the plurality of web pages:
obtaining page content of the web page by accessing the URL associated with the web page;
analyzing the page content of the web page based at least on the trademark name, the owner name and the goods/services information to generate a brand score indicative of a degree of confidence that the web page includes the trademark; and
analyzing the page content of the web page to generate a commercial score indicative of a degree of confidence that the web page relates to commerce;
presenting information about each web page in the plurality of web pages via a user interface (UI), the information about each web page including at least the URL of the web page and a representation of the brand score and the commercial score associated with the web page.

2. The method of claim 1, wherein the generating the search queries based at least on the information about the trademark comprises:
providing the goods/services information to a machine learning model to do one or more of:
extract a set of keywords from the goods/services information; or
identify a set of equivalent terms; and
generating the search queries based in part on one or more of the set of keywords or the set of equivalent terms.

3. The method of claim 1, wherein submitting the search queries to at least one Internet search engine to obtain a set of search results pertaining to a plurality of web pages comprises:
submitting the search queries to the at least one Internet search engine to obtain an initial set of search results; and
filtering the initial set of search results to eliminate web pages that correspond to irrelevant web pages identified in a blacklist.

4. The method of claim 1, wherein analyzing the page content of the web page based on the trademark name, the owner name and the goods/services information to determine the brand score comprises:
providing the goods/services information and the page content of the web page to a machine learning model that is trained on descriptions of goods/services of registered trademarks and trademark classes associated therewith to identify a measure of similarity between the goods/services information and the page content of the web page; and
determining the brand score for the web page based in part on the measure of similarity.

5. The method of claim 1, wherein analyzing the page content of the web page to determine the commercial score comprises:
comparing elements included in the page content of the web page to a predefined set of expected commercial web page elements; and
determining the commercial score for the web page based at least in part on the results of the comparing.

6. The method of claim 1, wherein presenting the information about each web page in the plurality of web pages via the UI comprises:
ranking each web page based on one or more of the brand score or the commercial score associated therewith; and
presenting the information about each web page in the plurality of web pages via the UI in an order determined by the rankings of the web pages.

7. The method of claim 1, further comprising:
for each web page in the plurality of web pages:
obtaining an excerpt of text from the web page; and
identifying one or more words within the excerpt that contributed to the generation of one or more of the brand score or the commercial score for the web page;
wherein the information about each web page that is presented via the UI includes the excerpt of text from the web page with the identified one or more words highlighted.

8. The method of claim 1, further comprising:
for each web page in the plurality of web pages:
identifying one or more elements within the page content of the web page that contributed to the generation of one or more of the brand score or the commercial score for the web page; and
modifying the page content of the web page to highlight the identified one or more elements;
wherein the information about each web page that is presented via the UI includes a rendering of the modified page content of the web page.

9. A system for obtaining evidence of online commercial use of a trademark, comprising:
at least one processor; and
at least one memory that stores program code that is executed by the at least one processor, the program code comprising:
a query generator that receives information about the trademark and generates search queries based thereon, the information about the trademark including at least a trademark name, an owner name and goods/services information;
a search results collector that submits the search queries to at least one Internet search engine to obtain a set of search results pertaining to a plurality of web pages, the search results pertaining to the plurality of web pages comprising at least a Uniform Resource Locator (URL) associated with each web page in the plurality of web pages;
a web page content analyzer that, for each web page in the plurality of web pages:
obtains page content of the web page by accessing the URL associated with the web page;
analyzes the page content of the web page based at least on the trademark name, the owner name and the goods/services information to generate a brand score indicative of a degree of confidence that the web page includes the trademark; and
analyzes the page content of the web page to generate a commercial score indicative of a degree of confidence that the web page relates to commerce;
a user interface (UI) manager that presents information about each web page in the plurality of web pages via a UI, the information about each web page including at least the URL of the web page and a representation of the brand score and the commercial score associated with the web page.

10. The system of claim 9, wherein the query generator provides the goods/services information to a machine learning model to extract a set of keywords from the goods/services information and generates the search queries based in part on the set of keywords.

11. The system of claim 9, wherein the query generator provides the goods/services information to a machine learning model to identify a set of equivalent terms and generates the search queries based in part on the set of equivalent terms.

12. The system of claim 9, wherein the search results collector obtains the set of search results pertaining to the plurality of web pages by:
submitting the search queries to at least one Internet search engine to obtain an initial set of search results; and
filtering the search results to eliminate web pages that correspond to irrelevant web pages identified in a blacklist.

13. The system of claim 9, wherein the web page content analyzer analyzes the page content of the web page based on the trademark name, the owner name and the goods/services information to determine the brand score by:
providing the goods/services information and the page content of the web page to a machine learning model that is trained on descriptions of goods/services of registered trademarks and trademark classes associated therewith to identify a measure of similarity between the goods/services information and the page content of the web page; and
determining the brand score for the web page based in part on the measure of similarity.

14. The system of claim 9, wherein the web page content analyzer analyzes the page content of the web page to determine the commercial score by:
comparing elements included in the page content of the web page to a predefined set of expected commercial web page elements; and
determining the commercial score for the web page based at least in part on the results of the comparing.

15. The system of claim 9, wherein the UI manager presents the information about each web page in the plurality of web pages via the UI by:
ranking each web page based on one or more of the brand score or the commercial score associated therewith; and
presenting the information about each web page in the plurality of web pages via the UI in an order determined by the rankings of the web pages.

16. The system of claim 9, wherein for each web page in the plurality of web pages, the web page content analyzer:
obtains an excerpt of text from the web page; and
identifies one or more words within the excerpt that contributed to the generation of one or more of the brand score or the commercial score for the web page; and
wherein the information about each web page that is presented via the UI includes the excerpt of text from the web page with the identified one or more words highlighted.

17. The system of claim 9, wherein for each web page in the plurality of web pages, the web page content analyzer:
identifies one or more elements within the page content of the web page that contributed to the generation of one or more of the brand score or the commercial score for the web page; and
modifies the page content of the web page to highlight the identified one or more elements; and
wherein the information about each web page that is presented via the UI includes a rendering of the modified page content of the web page.

18. A computer-readable storage medium having computer program logic recorded thereon that when executed by at least one processor causes the at least one processor to perform a method comprising:
receiving information about a trademark, the information about the trademark including at least a trademark name, an owner name and goods/services information;
generating search queries based at least on the information about the trademark;
submitting the search queries to at least one Internet search engine to obtain a set of search results pertaining to a plurality of web pages, the search results pertaining to the plurality of web pages comprising at least a Uniform Resource Locator (URL) associated with each web page in the plurality of web pages;
for each web page in the plurality of web pages:
obtaining page content of the web page by accessing the URL associated with the web page;
analyzing the page content of the web page based at least on the trademark name, the owner name and the goods/services information to generate a brand score indicative of a degree of confidence that the web page includes the trademark; and
analyzing the page content of the web page to generate a commercial score indicative of a degree of confidence that the web page relates to commerce;
presenting information about each web page in the plurality of web pages via a user interface (UI), the information about each web page including at least the URL of the web page and a representation of the brand score and the commercial score associated with the web page.

19. The computer-readable storage medium of claim 18, wherein the analyzing the page content of the web page based on the trademark name, the owner name and the goods/services information to determine the brand score comprises:
providing the goods/services information and the page content of the web page to a machine learning model that is trained on descriptions of goods/services of registered trademarks and trademark classes associated therewith to identify a measure of similarity between the goods/services information and the page content of the web page; and
determining the brand score for the web page based in part on the measure of similarity.

20. The computer-readable storage medium of claim 18, wherein the analyzing the page content of the web page to determine the commercial score comprises:
comparing elements included in the page content of the web page to a predefined set of expected commercial web page elements; and
determining the commercial score for the web page based at least in part on the results of the comparing.
